(19) United States
(12) Patent Application Publication
(10) Pub. No.: US 2007/0048536 A1
(43) Pub. Date: Mar. 1, 2007

(54) Tool with wear resistant coating

(75) Inventors: Monika Stoiber, Reutte (AT); Wolfgang Wallgram, Breitenwang (AT); Martin Kathrein, Reutte (AT)

Correspondence Address: LERNER GREENBERG STEMER LLP, P O BOX 2480, HOLLYWOOD, FL, 33022-2480, US

(73) Assignee: Ceratizit Austria Gesellschaft m.b.H.

(21) Appl. No.: 11/581,697

(22) Filed: Oct. 16, 2006

Related U.S. Application Data
(63) Continuation of application No. PCT/AT05/00120, filed on Apr. 6, 2005.

(30) Foreign Application Priority Data
Apr. 16, 2004 (AT) GM 287/2004

(51) Int. Cl. B32B 15/04; B32B 9/00

(52) U.S. Cl. 428/469; 428/471; 428/472; 428/472.2

(57) ABSTRACT

A tool or wearing part includes a base body and a single-layer or multilayer coating. At least one layer of the coating is formed of aluminum borate or contains aluminum borate phase fractions. Tools or wearing parts which have been coated in this way have a considerably improved resistance to abrasion, a high toughness and resistance to oxidation and a low coefficient of friction in contact with the wearing body, which leads to a significantly improved service life.

### CROSS-REFERENCE TO RELATED APPLICATIONS

This is a continuing application, under 35 U.S.C. §120, of copending International Application No. PCT/AT2005/000120, filed Apr. 6, 2005, which designated the United States; this application also claims the priority, under 35 U.S.C. §119, of Austrian Patent Application GM 287/2004, filed Apr. 16, 2004; the prior applications are herewith incorporated by reference in their entirety.

### BACKGROUND OF THE INVENTION

### Field of the Invention

The invention relates to a tool or wearing part which includes a base body made from hard metal, cermet, hard material or another wear-resistant material with a hardness of >700 HV (Vickers Hardness) and a single-layer or multilayer coating.

Hard metals, cermets, hard materials and other materials with a hardness of >700 HV are used for tools and wearing parts which are subject to high levels of wear. The term hard metal is to be understood as meaning a composite material which is composed of a hard material phase and a metallic binder. The cermet group of materials includes all materials which are composed of one or more ceramic phases and one or more metallic phases. The group of hard materials includes in particular compounds of the elements from groups IVa to VIa of the periodic system with the elements carbon, nitrogen, boron or silicon, as well diamond, cubic boron nitride, silicon carbide, aluminum nitride, Sialons, aluminum oxide, aluminum nitride and silicon nitride, to mention the most important.

In order to increase the resistance to wear, highly wear-resistant hard material coatings based on carbides, nitrides, borides, silicides and oxides are applied in particular to hard metals, cermets, hard materials and other materials with a hardness HV>700. Those coatings have hardnesses which are usually in a range of from 1500 HV to 4000 HV.

Under load, in addition to the wearing body (tool or wearing part), the tribological system also encompasses the opposing body causing wear and friction, any intermediate materials, the forces which are active, the sequence of movements and the environmental influences. In particular, if the forces which are active and the relative velocity between the wearing body and the opposing body are high, a considerable increase in temperature occurs in the wearing body/opposing body interface region. For example, temperatures of 1000° C. and above are measured at the surface of a machining tool. The reasons therefor are the deformation and cutting work in the shearing zone, friction between the chip and the tool face, and friction between the workpiece and the flank or side.

The thermal stressing or loading of the tool as a whole can be significantly reduced by coating with a smooth surface, low coefficients of friction and a low thermal conductivity.

The effect of increasing the wear resistance of hard material layers on wearing parts has been exploited at a commercial level for many years. Among the many hard material phases which have been used by now to protect against wear, firstly hard materials from the group of carbides and carbonitrides or nitrides and secondly those from the group of oxides, have proven particularly successful and are nowadays in widespread use as additional protective layers, generally in a coating layer sequence. In that context it is customary for coatings to be constructed in the form of a plurality of individual layers of different hard materials in order to satisfy different demands with regard to bonding, toughness and low wear.

By way of example, reference is made to single-layer or multilayer coatings, being formed of titanium carbide, titanium nitride, titanium carbonitride or aluminum oxide.

In the past, the requirement for coatings with improved tribological properties as compared to pure hard material layers has been satisfied in various ways. In that context, there are also approaches aimed at improving the properties of an Al₂O₃ coating by doping with boron. For example, European Patent Application EP 1 231 295 A2, corresponding to U.S. Pat. No. 6,726,987, describes a fine-crystal mixed oxide layer, predominantly including Al₂O₃, in which specific fractions of Ti oxide and boron oxide are dissolved or very finely and homogeneously distributed, and in which additions of from 0.1 to <3% by weight of TiO₂ and 0.01 to 0.5% by weight of B₂O₃ may be present. That document does not mention the formation of borates.

Furthermore, numerous attempts have also been made to reduce the coefficient of friction. In addition to lubricants or coolants, which are supplied when loading is present, there are also known measures involving depositing what are known as solid dry lubricating films on the wearing body. Those solid lubricants generally have a crystal structure with bonding forces which are highly directionally dependent. Examples include graphite, hexagonal boron nitride and molybdenum disulfide. An effective reduction in the coefficient of friction is only observed at relatively low temperatures. Moreover, those coatings are very soft and are rapidly abraded.

Oxides have also been investigated for use as solid lubricants. For example, Vanadium and tungsten oxides with a composition that is substoichiometric with regard to the oxygen content have been proposed. Those oxides form what are known as Magneli phases and are stable under an oxidizing environment up to high temperatures. However, the friction-reducing effect is insufficient in the event of high load combinations and high relative velocities between the wearing body and the opposing body.

### SUMMARY OF THE INVENTION

It is accordingly an object of the invention to provide a tool or wearing part with a wear-resistant coating, which overcomes the hereinafore-mentioned disadvantages of the heretofore-known devices of this general type and which has a high wear resistance, in particular abrasion resistance, a high toughness and oxidation resistance as well as a low coefficient of friction in contact with a wearing body.

With the foregoing and other objects in view there is provided, in accordance with the invention, a tool or wearing part. The tool or wearing part comprises a base body made from hard metal, cermet, hard material or another wear-resistant material with a hardness of >700 HV. A single-layer or multilayer coating has at least one layer being formed of aluminum borate or containing aluminum borate phase fractions.

Surprisingly, it has been found that coatings which contain aluminum borate, preferably having the structural formula Al₄B₂O₉ or Al₉B₄O₃₃, have a significantly improved service life, as is also documented in the examples. Aluminum borate has heretofore not been used for tools or wearing parts. Aluminum borate is used, for example, as a fiber material, as has been documented in European Patent Application EP 0 856 497 A1, corresponding to Patent Abstracts of Japan JP 10203880 and JP 10203878, Patent Abstracts of Japan JP 07041316 A, Patent Abstracts of Japan JP 05086424 A, Patent Abstracts of Japan JP 05085721 or Patent Abstracts of Japan JP 5330997 A. Its fluorescent property has also been exploited (see Korean Patent Documents KR 9312014 and KR 9312013).

The coating containing aluminum borate may be in single-layer or multilayer form. A multilayer coating has a sufficiently improved toughness. In the case of a multilayer coating, it is advantageous if the coating layer which contains aluminum borate forms a capping layer (top layer), which during operation comes into contact with the opposing body. However, it is also possible, as is also the case with multilayer systems containing Al₂O₃, for one or more further coating layers, for example of TiN, TiCN or coating layers made up of a multi-substance system including Ti, C, N, O, B, to be applied above the coating layer which contains aluminum borate. Furthermore, it is also possible for multiple layers of aluminum borate or coating layers including aluminum borate phase fractions to be applied, in which case the individual layers are separated by coating layers of a different composition, for example TiN, TICN or coating layers made up of a multi-substance system including Ti, C, N, O, B.

In accordance with a further feature of the invention, it has also been found that the advantageous effect is active within a wide coating or coating layer(s) composition range, namely for 10 to 99.99% by volume aluminum borate, 0.01 to 90% by volume aluminum oxide, 0 to 20% by volume titanium oxide, 0 to 40% by volume boron oxide and 0 to 10% by volume of a phase containing Cl, S, C, N or H. It can be assumed that aluminum borate reduces the coefficient of friction and has a good resistance to oxidation. The reduction in the coefficient of friction is achieved to a sufficient extent if at least 10% by volume aluminum borate is present in the coating or the coating layer. Optimum tool life quantities can be achieved if the coating or coating layer contains more than 70% by volume aluminum borate. In addition to the hard microstructural constituent aluminum borate, which reduces the coefficient of friction, it is also possible for further, oxidic hard material phases, preferably Al₂O₃, and in this case in turn preferably the kappa-Al₂O₃ modification, or TiO₂ to be contained in the coating or coating layer. However, other stable oxides, such as for example HfO₂ or ZrO₂, are also possible.

It is also possible for boron oxide to be present in the coating or coating layer up to a level of at most 40% by volume. Higher levels lead to an unacceptable drop in the hardness of the coating and to a deterioration in the thermal stability. A further improvement in the coating properties can be achieved by inclusions of Cl, S, C, N and/or H in chemically bonded, elemental or dissolved form, in a concentration range up to at most 10 and preferably 5% by volume. Furthermore, these elements, in the case of coating deposition through the use of CVD, lead to an increase in the deposition rate.

The preferred thicknesses for the aluminum borate coating or the coating layer containing aluminum borate are from 0.1 to 30 μm, with the optimum value being dependent on the application area. For many applications, for example turning or drilling, a range from 0.5 to 5 μm has proven suitable. In the case of multi-coating systems, it is similarly possible to use coating sequences which have already proven suitable for coating systems containing Al₂O₃. For example, coatings having the multi-substance system including Ti, Al, C, N, B, O have also proven suitable for aluminum borate as a bonding agent to the base body made from hard metal or cermet. Furthermore, it may be advantageous to apply a large number of thin aluminum borate or aluminum borate-containing coatings, in which case the individual coatings are separated by coatings from the multi-substance system including Ti, C, N, B, O.

In accordance with a concomitant feature of the invention, known coating processes, such as PVD, CVD under standard pressure and subatmospheric pressure conditions and PA-CVD processes, are suitable for applying the hard material coatings according to the invention. The text which follows provides a more detailed explanation of the invention using examples. In this case, production is carried out through the use of CVD.

Other features which are considered as characteristic for the invention are set forth in the appended claims.

Although the invention is illustrated and described herein as embodied in a tool with a wear-resistant coating, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a photograph showing a structure of a very fine crystal and smooth aluminum borate capping layer according to the invention;

FIG. 2 is a photograph showing a prior art coating system having an Al₂O₃ layer with a rougher surface structure;

FIG. 3 is a diagram plotting the maximum width of a wear mark against the number of parts being produced; and

FIG. 4 is a diagram plotting the wear against the number of finished parts.

### DESCRIPTION OF THE PREFERRED EMBODIMENTS

### Example 1

A multifunction tool for turning, drilling and face-turning made from hard metal (WC—9.5% by weight CO—8.5% by weight mixed carbide) was coated through the use of CVD at standard pressure. A coating sequence, starting from the hard metal base body, of TiN/TiCN/Al₂O₃/TiCNO/aluminum borate, was selected. The thicknesses of the individual layers were, in the same order, 1 μm, 2 μm, 1.2 μm, 0.15 μm, 1.2 μm. The aluminum borate layer contained trace amounts of the other elements of the process gas.

The reaction gases used to produce the coating corresponded to commercially available gases and were introduced in metered fashion through a gas mixing space into the reaction space, which was heated through the use of a tube furnace. The deposition temperature was 750-850° C., preferably 790-830° C. The gases used were substantially employed in the following mixture ratio: 45% by volume Ar, 45% by volume N₂, 1.6% by volume CO₂, 1.2% by volume AlCl₃, 0.1% by volume TiCl₄, 0.1% by volume BCl₃, 0.05% by volume H₂S, and a remainder of H₂.

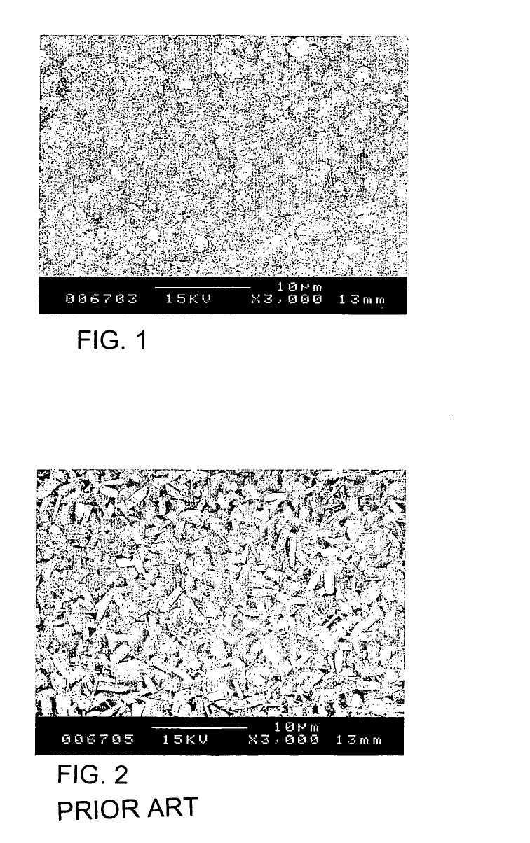

FIG. 1 shows the structural appearance of the very fine-crystal and smooth aluminum borate capping layer according to the invention. The individual crystallites of the aluminum borate layer have mean grain sizes in a range around 0.1 μm.

For comparison purposes, a coating system corresponding to the prior art was also deposited. In that case, the aluminum borate capping layer was replaced by an Al₂O₃ layer.

The latter has a significantly rougher surface structure, as is illustrated in FIG. 2.

These specimens were used to carry out machining tests. Ck 60 (1.1221) (German Industrial Standard DIN designation Ck60, material No. 1.1221) parts were in each case subjected, with the addition of coolant, to a drilling, turning and face-turning operation, using the following machining parameters:

Drilling:

v_{c}=150 m/min (cutting speed)
f=0.10 mm/rev (feed)
aₚ=(25 mm) (cutting depth)
   Turning:
v_{c}=200 m/min
f=0.15 mm/rev
ap=3.0 mm
   Face-Turning:
   v_{c}=200 m/min
f=0.15 mm/rev
aₚ=2.5 mm

The wear mark width was measured according to the number of finished parts, as is shown in FIG. 3. The tools with the aluminum borate coating according to the invention had a tool life which was increased by 40% as compared to the prior art.

### Example 2

A parting tool made from hard metal (WC—11% by weight Co—12% by weight mixed carbide) was coated through the use of CVD at standard pressure. A layer sequence, starting from the hard metal base body, of TiN, TiCN/Al₂O₃/TiCNO/(50% by volume aluminum borate—50% by volume aluminum oxide) was selected. The thicknesses of the individual layers, in the same order, were 1 μm, 2 μm, 1.2 μm, 0.15 μm, 1.2 μm. The aluminum borate/aluminum oxide coating included trace amounts of the further elements of the process gas.

The reaction gases used to produce the coating corresponded to commercially available gases and were introduced in metered fashion through a gas mixing space into the reaction space, which was heated through the use of a tube furnace. The deposition temperature was 850-920° C., preferably 865-890° C. The gases used were substantially employed in the following mixing ratio: 35% by volume Ar, 55% by volume N₂, 1.6% by volume CO₂, 1.2% by volume AlCl₃, 0.1% by volume TiCl₄, 0.1% by volume BCl₃, 0.05% by volume H₂S, and a remainder of H₂.

For comparison purposes, a coating system corresponding to the prior art was also deposited. In that case, the aluminum borate/aluminum oxide coating was replaced by an aluminum oxide layer.

These specimens were used to carry out machining tests. Ck 60 (1.1221) parts were in each case subjected with the addition of coolant to a plunge-cutting operation using the following machining parameters:

v_{c}=160 m/min

f=0.15 mm/rev
(aₚ=3.1 mm)

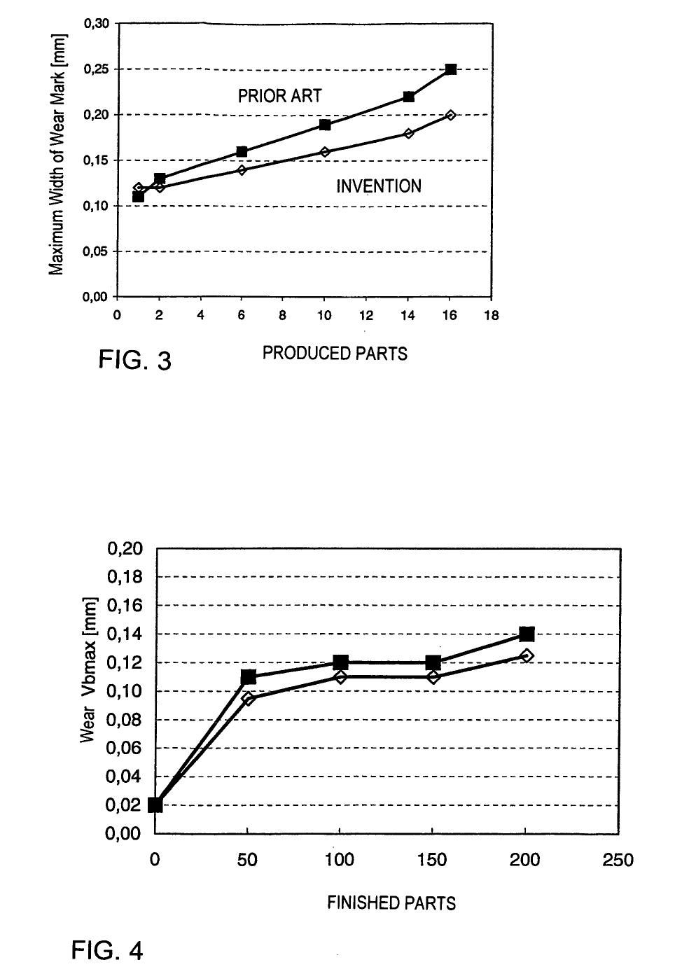

The wear mark width was measured according to the number of finished parts, as is shown in FIG. 4. The tools according to the invention on average had a service life 20% higher than the prior art.

We claim:

1. A tool or wearing part, comprising:
a base body made from hard metal, cermet, hard material or another wear-resistant material with a hardness of >700 HV; and
a single-layer or multilayer coating, at least one layer of said coating being formed of aluminum borate or containing aluminum borate phase fractions.

2. The tool or wearing part according to claim 1, wherein at least one layer of said coating contains aluminum borate and one or more phase constituents selected from the group consisting of aluminum oxide, boron oxide and titanium oxide, as well as optionally Cl, S, C, N and/or H in elemental form, in dissolved form or in the form of a compound.

3. The tool or wearing part according to claim 1, wherein at least one layer of said coating is formed of 10 to 99.99% by volume aluminum borate, 0.01 to 90% by volume aluminum oxide, 0 to 20% by volume titanium oxide, 0 to 40% by volume boron oxide and 0 to 10% by volume of a phase containing Cl, S, C, N and/or H.

4. The tool or wearing part according to claim 1, wherein at least one layer of said coating is formed of 70 to 99.9% by volume aluminum borate, 0.1 to 30% by volume aluminum oxide, 0 to 10% by volume titanium oxide, 0 to 20% by volume boron oxide, 0 to 5% by volume of a phase containing Cl, S, C, N and/or H.

5. The tool or wearing part according to claim 2, wherein said aluminum oxide has a structure of kappa-Al₂O₃.

6. The tool or wearing part according to claim 3, wherein said aluminum oxide has a structure of kappa-Al₂O₃.

7. The tool or wearing part according to claim 4, wherein said aluminum oxide has a structure of kappa-Al₂O₃.

8. The tool or wearing part according to claim 1, wherein at least one layer of said coating is formed of 50 to 99.99% by volume aluminum borate and 0.01 to 50% by volume boron oxide.

9. The tool or wearing part according to claim 1, wherein said aluminum borate has a structural formula Al₄B₂O₉ or Al₉B₄O₃₃.

10. The tool or wearing part according to claim 1, wherein at least one layer of said coating contains Cl, S, C, N and/or H in dissolved form.

11. The tool or wearing part according to claim 1, wherein at least one layer of said coating contains Cl, S, C, N and/or H in elemental and very finely distributed form.

12. The tool or wearing part according to claim 1, wherein said at least one layer of said coating formed of aluminum borate or containing aluminum borate phase fractions, has a thickness of from 0.1 to 30 μm.

13. The tool or wearing part according to claim 1, wherein said at least one layer of said coating formed of aluminum borate or containing aluminum borate phase fractions, has a thickness of from 0.5 to 5 μm.

14. The tool or wearing part according to claim 1, wherein said coating is a multilayer coating.

15. The tool or wearing part according to claim 14, wherein one or more layers of said coating predominantly contain aluminum borate and/or aluminum oxide.

16. The tool or wearing part according to claim 14, wherein one or more layers of said coating are formed of titanium nitride, titanium carbide or titanium carbonitride, optionally with additions of O and/or B.

17. The tool or wearing part according to claim 15, which further comprises a coating of titanium nitride, titanium carbide or titanium carbonitride, optionally with additions of O and/or B, being introduced between said base body and said coating containing aluminum borate and/or aluminum oxide.

18. The tool or wearing part according to claim 15, which further comprises a coating of titanium nitride, titanium carbide or titanium carbonitride, optionally with additions of O and/or B, being introduced between coatings containing aluminum borate and/or aluminum oxide.

19. The tool or wearing part according to claim 14, wherein said layer of said coating formed of aluminum borate or containing aluminum borate phase fractions, forms a top layer.

20. The tool or wearing part according to claim 1, wherein said single-layer or multilayer coating is produced by CVD.

21. The tool or wearing part according to claim 1, wherein said single-layer or multilayer coating is produced by PA-CVD.

22. The tool or wearing part according to claim 1, wherein said single-layer or multilayer coating is produced by PVD.
